(19) United States
(12) Patent Application Publication
(10) Pub. No.: US 2009/0000778 A1
(43) Pub. Date: Jan. 1, 2009

(54) Control scheme for an occupant environment conditioning system of a vehicle

(75) Inventors: John F. Nathan, Highland, MI (US); Karl Kennedy, Fraser, MI (US); H. Winston Maue, Farmington Hills, MI (US); Santosh Karumathil, Thane (W) (IN)

Correspondence Address: MACMILLAN, SOBANSKI & TODD, LLC, ONE MARITIME PLAZA-FIFTH FLOOR, 720 WATER STREET, TOLEDO, OH, 43604, US

(73) Assignee: Lear Corporation

(21) Appl. No.: 11/821,804

(22) Filed: Jun. 26, 2007

(51) Int. Cl. B60H 1/00; G05D 23/00

(52) U.S. Cl. 165/202; 700/278

(57) ABSTRACT

An occupant environment conditioning system for a vehicle includes a controller that selectively operates at least one device for altering an environment of a vehicle occupant based a power cost analysis.

### BACKGROUND OF THE INVENTION

This invention relates in general to environmental conditioning systems for occupant compartments of vehicles, and in particular, to a control scheme for an environmental conditioning system for an occupant compartment of a vehicle.

Almost all passenger vehicles include a system for conditioning the environment of a vehicle occupant, i.e. the interior occupant compartment. Typically, these systems include a conventional Heating, Ventilation, and Air Conditioning (HVAC) system, one or more seat heaters, one or more seat coolers, and a variety of other devices, including for example integrated seat ventilation such as described in U.S. Pat. No. 6,578,910, issued Jun. 17, 2003, the disclosure of which is incorporated herein by reference. Due to a growing interest in improved fuel economy in traditional gasoline/diesel, flex-fuel, and alternative fuel vehicles, and with renewed development of electric and fuel-electric hybrid vehicles there has been increased attention to the power consumption of occupant environmental conditioning systems in vehicles. For example, U.S. patent application No. 2007/0017666 discloses a vehicle system including an HVAC device and a thermal storage device, both configured to provide heating and cooling to an occupant compartment of the vehicle. The system further includes a controller that directs at least one of the HVAC device and the thermal storage device to provide heating and cooling to the occupant compartment of the vehicle, depending on the available storage of the thermal storage unit or occupant compartment demands.

### SUMMARY OF THE INVENTION

This invention relates to a control scheme for an occupant environmental conditioning system of a vehicle that operates at least one environmental conditioning device based on a power cost analysis.

The environmental conditioning system includes a controller that selectively operates at least one device for altering an environment of a vehicle occupant based at least in part on a desired condition indicated by a user input device, and a vehicle parameter indicated by a system input device, and that operates the device based at least in part upon a power management algorithm.

Various objects and advantages of this invention will become apparent to those skilled in the art from the following detailed description and accompanying drawings.

### BRIEF DESCRIPTION OF THE DRAWINGS

FIG. 1 is a schematic diagram of a vehicle occupant environment conditioning system in accordance with a first embodiment of the present invention.

FIG. 2 is a schematic diagram of a vehicle occupant environment conditioning system in accordance with a second embodiment of the present invention.

### DETAILED DESCRIPTION OF THE PREFERRED EMBODIMENT

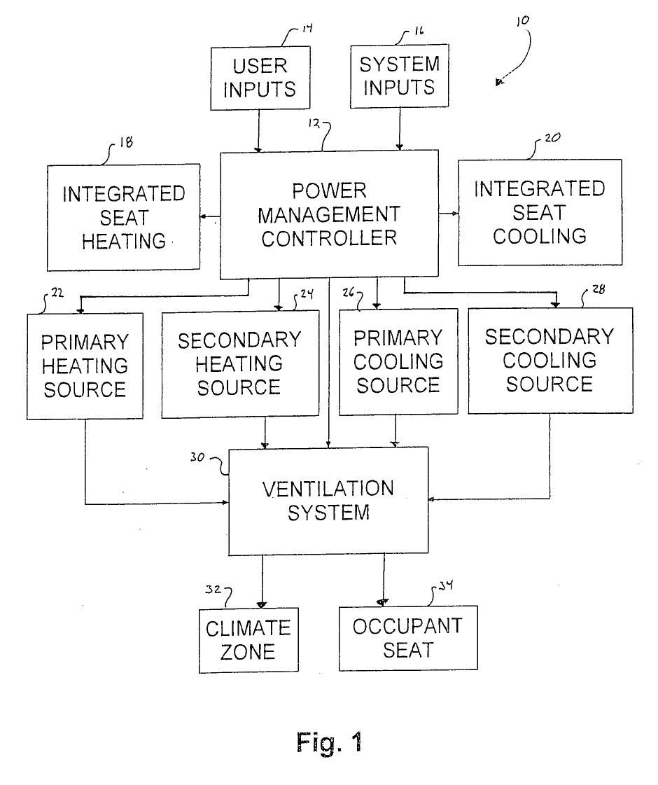

Referring now to the drawings, there is illustrated in FIG. 1 a vehicle occupant environment conditioning system 10 in accordance with a first embodiment of the present invention. The vehicle occupant environment conditioning system 10 is a system for controlling the environment of a vehicle occupant compartment. It must be understood that the system 10 is illustrated schematically and that FIG. 1 is not intended to necessarily represent that actual configuration or architecture of the system 10.

The vehicle occupant environment conditioning system 10 includes a power management controller 12, the purpose of which will be further described below. A plurality of user input devices 14 are connected to the controller 12. The plurality of user input devices 14 may include a desired temperature indicator, fan speed indicator, and/or an automatic control setting indicator. In the present embodiment, at least one environmental profile is stored in the controller 12, and the plurality of user input devices includes at least one key fob or vehicle remote control, which is linked to the activation of the environmental profile. In one embodiment, the controller 12 recognizes the driver of the vehicle via the key fob, remote control, or any other suitable device, and actives the associated environmental profile. It must be understood, however, that the system 10 need not include all of the above listed devices nor any one particular user input device. Indeed, the system 10 need only include at least one user input device that indicates at lease one desired condition of the vehicle occupant compartment.

A plurality of vehicle system input devices 16 are connected to the power management controller 12. The plurality of vehicle system input devices 16 may include an outside temperature indicator, an occupant compartment temperature indicator, and/or any other input device to indicate an environmental parameter in or about the vehicle. Additionally, the plurality of vehicle system input devices 16 includes an occupant sensor for indicating the presence of an occupant in a vehicle seat. Further, the plurality of vehicle system input devices 16 includes several indicators for indicating the status of several other components of the vehicle, some of which will be further described below. It must be understood, however, that the system 10 need not include all of the above listed devices nor any one particular of vehicle system input device. Indeed, the system 10 need only include at least one of vehicle system input device that indicates at least one parameter of the vehicle.

The system 10 further includes a plurality of occupant environment conditioning devices for altering the environment of the vehicle occupant. The plurality of occupant environment conditioning devices may include an integrated seat heater 18 and/or an integrated seat cooler 20, although neither are required. The seat heater 18 includes a heat mat with a thermoelectric device, such as an electrically heated wire. It must be understood, however, that the heat mat may include any electrically resistant element that generates heat. Additionally, the seat heater 18 and the seat cooler 20 include ductwork integrated into the seat with a switchable heating-cooling source, such as a thermoelectric device, such as a Peltier device. The air from the ducts may be blown through perforations in the seating surface of the seat and onto the occupant, as desired. Regarding the integrated ductwork, the seat heater 18 or the seat cooler 20 may operate in an active or passive manner. That is to say that an air handling device may convey air through the duct work with the heating or cooling source operating or not, thus, actively conditioning the air or merely recirculating the occupant compartment air through the seat. It must also be understood that the seat cooler 20 may include a cool mat with a thermo-electric device, such as a Peltier cooler, or any other device suitable to provide direct or indirect cooling to the occupant of a vehicle through the seat. Further, the ductwork may be adjustable such that the output of air may be directed toward a particular occupant in the seat depending upon the size and location of the occupant.

In one embodiment, the system 10 includes an integrated heat heater 18 in which the seat includes a cushion heat pad, a back heat pad, a cushion sensor, and a back sensor. The cushion sensor detects the presence and/or position of a seat occupant and makes this information available to the power management controller 12 as a system input device 16. The controller 12 then controls the seat heating device 18 accordingly. For example, in the case where it is detected that the seat occupant is leaning forward and not resting against the seat back the controller 12 may direct the seat heating device 18 to turn off the back heat pad and thus conserve power.

The plurality of occupant environment conditioning devices may also include a primary heating source 22 and a secondary heating source 24. In the case of a traditional internal combustion engine vehicle, alternative fuel engine vehicle or hybrid vehicle the primary heating source 22 may be a conventional heating core drawing heat from the engine. In the case of the electric engine vehicle or hybrid vehicle, the primary heating source 22 may be an electric heating element. In any case the primary heating source 22 may be any device suitable to provide the main heating for the occupant compartment of the vehicle. In the case of the traditional internal combustion engine vehicle, alternative fuel engine vehicle or hybrid vehicle the secondary heating source 24 may be a thermo or thermoelectric recovery unit from the exhaust of the engine. In the case of the electric engine vehicle or hybrid vehicle, the battery/energy storage device(s) often require a separate environmental conditioning system so that the battery(ies) do not over heat or over cool. The secondary heating source 24 may be the environmental conditioning system for the batteries of the electric system. In any case, the secondary heating source 24 may any device suitable to provide auxiliary heating for the occupant compartment of the vehicle. For further example, it is noted that the secondary heating source 24 may even by the heat exhaust of another vehicle system, such as, but not limited to, the heat from a refrigeration system, such as for cooled glove boxes or for vehicles equipped with beverage refrigerators.

The plurality of occupant environment conditioning devices also include a primary cooling source 26 and a secondary cooling source 28. The primary cooling source 22 may be a conventional Air Conditioning (A/C) compressor unit driven by the main engine of the vehicle or any other device suitable to provide the main cooling for the occupant compartment of the vehicle. The secondary heating source 24 may be a thermo or thermoelectric unit for conversion of energy into cooling potential, such as a Peltier device. Alternatively, the secondary cooling device 28 may be the cooling potential of another vehicle system, such as, but not limited to, a refrigeration system, such as for cooled glove boxes or for vehicle equipped beverage refrigerators. It must be understood, however, that the secondary cooling device 28 may be any device suitable to provide auxiliary cooling for the occupant compartment of the vehicle. Further, it must be noted that in the case of the electric engine vehicle or hybrid vehicle, the secondary cooling source 28 may be the environmental conditioning system for the batteries of the electric system or any other sub-system suitable to provide auxiliary cooling.

The plurality of occupant environment conditioning devices also includes the components of a ventilation system 30. The ventilation system 30 includes one or more blowers, fans, or air handlers/conveyors to move air through ductwork or other air carriers of the ventilation system and occupant compartment. The ventilation system 30 may operate in conjunction with the primary heating source 22, the secondary heating source 24, the primary cooling source 26, and/or the secondary cooling source 28 to provide conditioned air to desired locations of the occupant compartment of the vehicle. Alternatively, the ventilation system 30 may operate alone to provide outside (vented) air to the occupant compartment or to circulate the air within the occupant compartment. The ventilation system 30 may provide air flow directly to any (one or more) defined climate zone 32 or the ventilation system 30 may provide air flow to or through any (one or more) occupant seat 34. The air flow to or through the occupant seat 34 may supplement or function in place of the integrated seat heating 18 or integrated seat cooling 20 of any particular occupant seat 34 as desired.

Preferably, the status of the plurality of environmental conditioning devices are available to the power management controller though one or more of the system inputs 16. This status information may include, but not be limited to, operating state, capacity, and the like. For example, the primary cooling deice 26 may provide the status of primary cooling unit to indicate weather or not it is already cooled. If not, the energy cost of initially cooling the unit may be accounted for by the power management controller 12.

It must be understood that the power management controller 12 may be a single integrated device or that the power management controller 12 may be dispersed throughout the systems of the vehicle, or that the power management controller may take any other suitable form. For example, the power management controller 12 may include a variety of control mechanisms and/or processors from any of a variety of systems within the vehicle. In one embodiment, the controller 12 includes a central electronic control unit (ECU) programmed with a power management algorithm and a plurality of control/actuation devices for the plurality environmental conditioning devices in electrical communication with the ECU.

In operation, the power management controller 12 operates at least one of the plurality of occupant environment conditioning devices based on a power management algorithm including a power cost analysis responsive to at least one desired condition indicated by at least one user input device, and at least one vehicle parameter indicated by at least one system input devices. It must be understood that the power cost analysis may be a decision tree with determinations being made based on the user input and system input, or that the power cost analysis may be a look-up table using the user input and the system input at the determining variable for the control function, or that the power cost analysis may be any programmed mechanism for controlling any one of the plurality of environmental conditioning devices based upon the cost of power consumption.

For example, one preferred method of operating the occupant environment conditioning system 10 follows.

A desired condition of the vehicle passenger compartment is provided to the power management controller 12 by one of the user input devices 14. The user input device 14 may be a thermostatic selector indicating a desired temperature of the vehicle passenger compartment, an airflow selector indicating a desired air stream with in the vehicle, or a profile indicator indicating a desired environmental control scheme for the vehicle. For example, the profile indicator may be a key fob or remote unit associated with a particular user profile including environmental controls. The power management controller 12 may then select a particular environmental profile based upon the profile indicator. Alternatively, environmental profile information may be saved in the key fob or remote device and upon user activation, or passive transmission the key fob or remote device provides the profile information to the controller 12. Such information may be provided to automatically adjust the environmental controls based upon the desire of a particular occupant.

At least one parameter of the vehicle is provided to the power management controller 12 by a plurality of vehicle system input devices 16. The vehicle system input devices 16 may indicate the external ambient temperature to the vehicle, the temperature of the occupant compartment, the status of one or more vehicle systems, the presence and/or position of an occupant on a vehicle seat by an occupant detection system, and the like. It should be noted that the occupant detection system may be an optical imagining system, an IR or RF sensor device, a pressure sensor system, and/or any other mechanism for detecting the presence and/or position of an occupant. Further, the occupant sensor may be the occupant sensor associated with an airbag assembly.

The power management controller 12 evaluates the desired condition indicated by the user input device 14, and the vehicle parameter(s) indicated by the system input device(s) 16 with a power management algorithm including a power cost analysis. The controller 12 then selectively operates one or more of the plurality of occupant environment conditioning devices based on the result of the evaluation.

In one embodiment, the plurality of occupant environment conditioning devices are active devices that use electrical power to generate heating or cooling. The selection of these devices may be determined based on real-time use and/or capacity. In one example, the power management controller 12 controls the plurality of devices to use excess capacity in first preference. In another example, the power management controller 12 controls the plurality of devices to utilize the devices in order of energy efficiency. In yet another example, the power management controller 12 operates the devices only as necessary as determined by an analysis of occupant perception.

In one embodiment, the method includes defining a plurality of occupant climate zones within the vehicle. The occupancy of at least one climate zones is determined with at least one of the plurality of vehicle system input devices 16. The power management algorithm is response to the occupancy determined to control at least one of the plurality of occupant environment conditioning devices.

In another embodiment, user input devices 14 are provided for one or more occupant climate zones separately. The plurality of occupant environment conditioning devices are controlled to reduce power consumption based on the separately defined user inputs.

In yet another embodiment, the occupant environment conditioning system 10 is controlled based upon occupant seating and/or position. For example, the system input devices 16 may include an occupant sensing mat, alone or integrated with other devices such as the heating or cooling mats for detecting the presence and/or position of an occupant on the seat. The system input devices 16 may, however, include any suitable seat occupant sensors and/or position detectors. The plurality of occupant environment conditioning devices may then be controlled to target the position of the occupants with in the occupant compartment and reduce vehicle occupant environment conditioning power consumption to areas and positions that do not include an occupant. For example, the system device that provide conditioning to a occupant zone that includes no occupant may be turned off or run at reduced power, and/or in zone where an occupant is present the devices within zone may be directed toward the occupant. For example, the intergraded heating and cooling devices 18 and 30 may be controlled to only activate with regards to portions of the seat in contact with the occupant and/or venting/ductwork may be controlled to direct airflow only toward the occupant.

It should be noted that by de-powering or reduced powering any of the plurality of occupant environment conditioning devices that would otherwise be active, the occupant environment conditioning system 10 will use less energy and, in the case of an electric vehicle for example, increase the driving range capability, and in the case of a traditional or alternative fuel vehicle will increase the miles/unit fuel.

It should also be noted that the occupant environment conditioning system 10 may operate the ventilation system 30 without the aid of other occupant environment conditioning devices based on the principals of evaporative cooling. To this effect, the power management controller may control the plurality of occupant environment conditioning devices based upon the difference between the desired occupant compartment temperature and the actual occupant compartment temperature. In this case, the power management algorithm calculated the cooling effect perceived by an occupant based upon the wind chill effect and with the power cost calculation operated the cooling sources 26 and 28 as little as possible to conserve energy. It must be understood that this includes the airflow to the climate zone 32 or to the occupant seat 34.

In another embodiment, the power cost analysis includes the use of the temperature gradient, the disparity between the desired and actual temperatures of the occupant compartment, in conjunction with the energy cost to operate a particular occupant environment conditioning device along with the energy cost to prime that device, or bring the device into a fully functional state. The power management controller 12 will then operate the plurality of occupant environment conditioning devices based upon the results of the analysis.

It should be noted that in one embodiment the system 10 includes adaptive or switchable ducting in the ventilation system 30 to direct the plurality of other occupant environment conditioning device to any of the climate zones 32 or occupant seats 34 in a variety of occupant zones as desired.

Additionally, it is expected that in addition to reduced power consumption as compared to conventional occupant environment conditioning systems, the occupant environment conditioning system 10 will have faster perceived temperature change to the occupant, based upon the efficient use of the plurality of occupant environment conditioning devices with the power management algorithm.

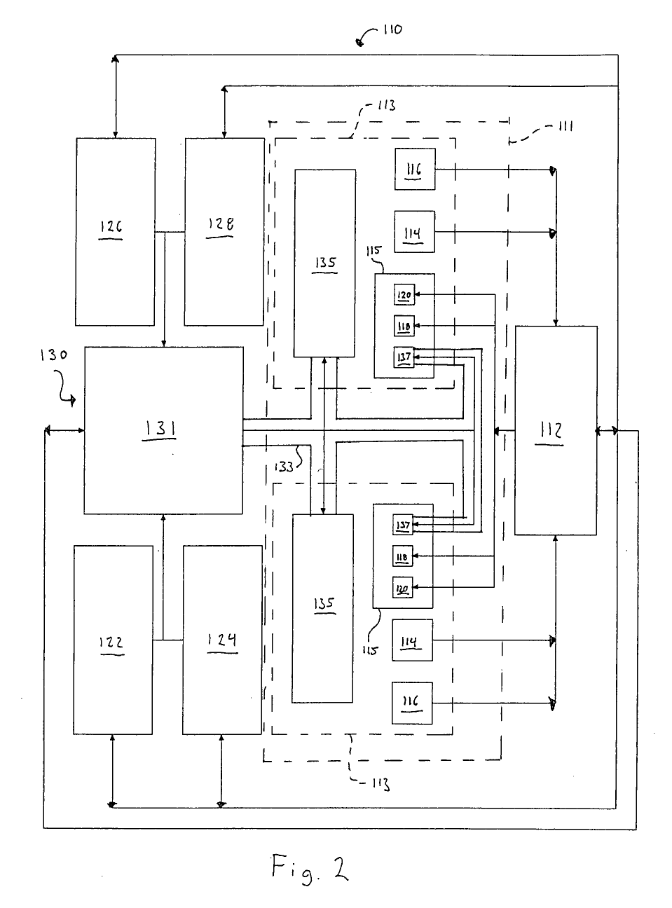

Referring now to FIG. 2, there is illustrated a vehicle occupant environment conditioning system 110 in accordance with a second embodiment of the present invention. The vehicle occupant environment conditioning system 110 is a system for controlling the environment of a vehicle occupant compartment 111, in particular for an electric vehicle, although such is not required. It must be understood that the system 110 is illustrated schematically and that FIG. 2 is not intended to necessarily represent that actual configuration or architecture of the system 110.

The vehicle occupant environment conditioning system 110 includes a power management controller 112, the purpose of which will be further described below. The vehicle occupant compartment 111 includes a plurality of occupant zones 113. Two zones 113 are shown. However, it must be understood that the occupant compartment 111 may includes any number of occupant zones as desired to section the occupant compartment 111 for environmental conditioning. A plurality of user input devices 114 are connected to the controller 112. The plurality of user input devices 114 may include a desired temperature indicator, fan speed indicator, and/or an automatic control setting indicator. Preferably, one of the plurality of input devices 114 is associated with one of the plurality of zones 113. For example, in one embodiment, the occupant compartment 111 includes a plurality of occupant seats 115, each of which are associated with a zone 113. The user input device 114 associated with the zone 113 is also associated with the seat 115 and/or an occupant seated therein.

For example, in the present embodiment, at least one environmental profile may stored in the controller 112, and the plurality of user input devices 114 may includes at least one key fob or vehicle remote control, which is linked to the activation of the environmental profile. In another example, the controller 112 may recognize the driver of the vehicle via the key fob, remote control, or any other suitable device, and actives the associated environmental profile. It must be understood, however, that the system 110 need not include all of the above listed devices nor any one particular user input device 114. Indeed, the system 110 need only include at least one user input device 114 that indicates at lease one desired condition of the vehicle occupant compartment 111.

A plurality of vehicle system input devices 116 are connected to the power management controller 112. The plurality of vehicle system input devices 116 may include an outside temperature indicator, an occupant compartment temperature indicator, and/or any other input device to indicate an environmental parameter in or about the vehicle. Additionally, the plurality of vehicle system input devices 116 may include an occupant sensor for indicating the presence of an occupant in the vehicle seat 115. As illustrated in FIG. 2 at least one system input device 116 is associated with one zone 113 and/or seat 115. It must be understood, however, that the system 10 need not include all of the above listed devices nor any one particular of vehicle system input device. Indeed, the system 10 need only include at least one of vehicle system input device that indicates at least one parameter of the vehicle.

The system 110 further includes a plurality of occupant environment conditioning devices for altering the environment of the vehicle occupant. The plurality of occupant environment conditioning devices may include an integrated seat heater 118, although such is not required. The seat heater 118 includes a heat mat with a thermoelectric device for generating heating, such as an electrically heated wire. It must be understood, however, that the heat mat may include any electrically resistant element that generates heat. The heat mat of the heat heater 118 will generate heat that will radiate through the seat 115 to the occupant zone 113 and/or an occupant seated in the seat 115.

In one embodiment, the system 110 also includes an integrated heat heater 118 in which the seat 115 includes a cushion heat pad, a back heat pad, a cushion sensor, and a back sensor. The cushion sensor detects the presence and/or position of a seat occupant and makes this information available to the power management controller 112 as a system input device 116. The controller 112 then controls the seat heating device 118 accordingly. For example, in the case where it is detected that the seat occupant is leaning forward and not resting against the seat back of the seat 115 the controller 112 may direct the seat heating device 118 to turn off the back heat pad and thus conserve power.

The system 110 further includes an integrated heated/cooled seat ventilation system 120, although neither are required. The integrated seat ventilation system 120 includes ductwork integrated into the seat 115 with a switchable heating-cooling source, such as a thermoelectric device that generates heating and/or cooling for the integrated seat ventilation system 120. For example, the thermo-electric device may be a Peltier device, or any other device suitable to generate heating or cooling for the integrated seat ventilation system 120. The air from the ducts of the integrated seat ventilation system 120 may be blown through perforations in the seating surface of the seat 115 and in to the zone 113 and/or onto the occupant of the seat 115, as desired. Regarding the integrated ductwork, the integrated seat ventilation system 120 may operate in an active or passive manner. That is to say that an air handling device may convey air through the duct work with the heating or cooling source operating or not, thus, actively conditioning the air or merely recirculating the occupant compartment air through the seat 115. Further, the ductwork may be adjustable such that the output of air may be directed toward a particular occupant in the seat depending upon the size and location of the occupant.

The plurality of occupant environment conditioning devices may also include a primary heating source 122 and a secondary heating source 124. In the case of a traditional internal combustion engine vehicle, alternative fuel engine vehicle or hybrid vehicle the primary heating source 122 may be a conventional heating core drawing heat from the engine, i.e. the heating core utilizes heat generated by the engine. In the case of the electric engine vehicle or hybrid vehicle, the primary heating source 122 may be an electric heating element for generating heat from electric power. In any case, the primary heating source 22 may be any device suitable to provide the main heating for the occupant compartment 111 of the vehicle. In the case of the traditional internal combustion engine vehicle, alternative fuel engine vehicle or hybrid vehicle the secondary heating source 124 may be a thermo or thermo-electric recovery/storage unit from the exhaust of the engine. In such a case, thermo-electric devices recover heat from the engine or exhaust to generate electric power and the electric power is then deliver to thermo-electric devices that actively use the electricity to generate heating. The heating is then stored in the thermal storage device, such as a phase change based device for passive recovery by the system 110. In such a case the operation of the thermo-electric devices is controlled based upon the excess heat available and the remaining storage capacity of the storage unit. In the case of the electric engine vehicle or hybrid vehicle, the battery/energy storage device(s) often require a separate environmental conditioning system so that the battery(ies) do not over heat or over cool. The secondary heating source 124 may be the environmental conditioning system for the batteries of the electric system. In such a case, the battery conditioning system could include, for example, an electric heating element that generates heat from electric power. In any case, the secondary heating source 124 may any device suitable to provide auxiliary heating for the occupant compartment of the vehicle. For further example, it is noted that the secondary heating source 124 may even by the heat exhaust of another vehicle system, such as, but not limited to, the heat from a refrigeration system, such as for cooled glove boxes or for vehicles equipped with beverage refrigerators, using a compressor to generate heat exhaust.

The plurality of occupant environment conditioning devices also include a primary cooling source 126 and a secondary cooling source 128. The primary cooling source 122 may be a conventional Air Conditioning (A/C) compressor unit for generating cooling driven by the main engine of the vehicle via a belt system or driven by a motor drawing electrical power from an alternator or the batteries. It must be understood, however, that the primary cooling source 122 may be any device suitable to provide the main cooling for the occupant compartment of the vehicle. The secondary heating source 124 may be a thermo or thermo-electric unit that uses electricity to generate cooling, such as a Peltier device. Alternatively, the secondary cooling device 128 may be the cooling generated by another vehicle system, such as, but not limited to, a refrigeration system, such as for cooled glove boxes or for vehicle equipped beverage refrigerators. It must be understood, however, that the secondary cooling device 128 may be any device suitable to provide auxiliary cooling for the occupant compartment of the vehicle. Further, it must be noted that in the case of the electric engine vehicle or hybrid vehicle, the secondary cooling source 128 may be the cooling generator of the environmental conditioning system for the batteries of the electric system or any other sub-system suitable to provide auxiliary cooling.

The plurality of occupant environment conditioning devices also includes the components of a ventilation system 130. The ventilation system 130 includes one or more blowers, fans, or air handlers/conveyors 131 to move air through ductwork 133 or other air carriers of the ventilation system 130 and occupant compartment 111. The ventilation system 130 may operate in conjunction with the primary heating source 122, the secondary heating source 124, the primary cooling source 126, and/or the secondary cooling source 128 to provide conditioned air to desired locations of the occupant compartment 111 of the vehicle. Alternatively, the ventilation system 130 may operate alone to provide outside (vented) air to the occupant compartment 111 or to circulate the air within the occupant compartment 111. The ventilation system 130 may provide air flow directly to any (one or more) of the climate zones 113 via cabin vents 135 or the ventilation system 130 may provide air flow to or through any (one or more) of the occupant seats 115 via seat vents 137. The air flow to or through the occupant seat 115 may supplement or function in place of the integrated seat ventilation system 120 of any particular occupant seat 115 as desired.

Further, in one embodiment, the plurality of environmental conditioning devices are in communication with the power management control 112 to indicate the status of one or more of the environmental conditioning devices to the controller 112. This status information may include, but not be limited to, operating state, capacity, and the like. For example, the primary cooling deice 126 may provide the status of primary cooling unit to indicate weather or not it is already cooled. If not, the energy cost of initially cooling the unit may be accounted for by the power management controller 112.

It must be understood that the power management controller 112 may be a single integrated device or that the power management controller 112 may be dispersed throughout the systems of the vehicle, or that the power management controller 112 may take any other suitable form. For example, the power management controller 112 may include a variety of control mechanisms and/or processors from any of a variety of systems within the vehicle. In one embodiment, the controller 112 includes a central electronic control unit (ECU) programmed with a power management algorithm and a plurality of control/actuation devices for the plurality environmental conditioning devices in electrical communication with the ECU.

In operation, the power management controller 12 operates at least one of the plurality of occupant environment conditioning devices for generating heating or cooling based on a power management algorithm including a power cost analysis responsive to at least one desired condition indicated by at least one user input device, and at least one vehicle parameter indicated by at least one system input devices. It must be understood that the power cost analysis may be a decision tree with determinations being made based on the user input and system input, or that the power cost analysis may be a look-up table using the user input and the system input at the determining variable for the control function, or that the power cost analysis may be any programmed mechanism for controlling any one of the plurality of environmental conditioning devices based upon the cost of power consumption.

For example, one preferred method of operating the occupant environment conditioning system 10 follows.

A desired condition of the vehicle passenger compartment is provided to the power management controller 112 by one of the user input devices 114. The user input device 114 may be a thermostatic selector indicating a desired temperature of the vehicle passenger compartment, an airflow selector indicating a desired air stream with in the vehicle, or a profile indicator indicating a desired environmental control scheme for the vehicle. For example, the profile indicator may be a key fob or remote unit associated with a particular user profile including environmental controls. The power management controller 112 may then select a particular environmental profile based upon the profile indicator. Alternatively, environmental profile information may be saved in the key fob or remote device and upon user activation, or passive transmission the key fob or remote device provides the profile information to the controller 112. Such information may be provided to automatically adjust the environmental controls based upon the desire of a particular occupant.

At least one parameter of the vehicle is provided to the power management controller 112 by a plurality of vehicle system input devices 116. The vehicle system input devices 16 may indicate the external ambient temperature to the vehicle, the temperature of the occupant compartment, the status of one or more vehicle systems, the presence and/or position of an occupant on a vehicle seat by an occupant detection system, and the like. It should be noted that the occupant detection system may be an optical imagining system, an IR or RF sensor device, a pressure sensor system, and/or any other mechanism for detecting the presence and/or position of an occupant. Further, the occupant sensor may be the occupant sensor associated with an airbag assembly.

The power management controller 112 evaluates the desired condition indicated by the user input device 114, and the vehicle parameter(s) indicated by the system input device(s) 116 with a power management algorithm including a power cost analysis. The controller 112 then selectively operates one or more of the plurality of occupant environment conditioning devices based on the result of the evaluation. It may be the case that the needed heating or cooling may be partially supplied by a passive, non-generating, device such as a traditional heating core or phase change thermal storage device. However, when the heating or cooling desired can not be fully supplied by a passive device, the environmental conditioning system 110 must utilize an active, heating/cooling generating, device to provide or supplement the heating or cooling.

Thus, in one embodiment, the power management controller must make a selection of the plurality of occupant environment conditioning devices are active devices that use power, such as electrical power, to generate heating or cooling. The selection of these devices may be determined based on real-time use and/or capacity. In one example, the power management controller 112 controls the plurality of devices to use excess capacity in first preference. In another example, the power management controller 112 controls the plurality of devices to utilize the devices in order of energy efficiency. In yet another example, the power management controller 112 operates the devices only as necessary as determined by an analysis of occupant perception.

In one embodiment, the method includes defining a plurality of occupant climate zones 113 within the vehicle. The occupancy of at least one climate zones 113 is determined with at least one of the plurality of vehicle system input devices 116. The power management algorithm is response to the occupancy determined to control at least one of the plurality of occupant environment conditioning devices.

In another embodiment, user input devices 114 are provided for one or more occupant climate zones 113 separately. The plurality of occupant environment conditioning devices are controlled to reduce power consumption based on the separately defined user inputs.

In yet another embodiment, the occupant environment conditioning system 10 is controlled based upon occupant seating and/or position. For example, the system input devices 16 may include an occupant sensing mat, alone or integrated with other devices such as the heating or cooling mats for detecting the presence and/or position of an occupant on the seat. The system input devices 16 may, however, include any suitable seat occupant sensors and/or position detectors. The plurality of occupant environment conditioning devices may then be controlled to target the position of the occupants with in the occupant compartment and reduce vehicle occupant environment conditioning power consumption to areas and positions that do not include an occupant. For example, the system device that provide conditioning to a occupant zone 113 that includes no occupant may be turned off or run at reduced power, and/or in zone 113 where an occupant is present the devices within zone may be directed toward the occupant. For example, the seat heater 118 and/or the intergraded heating and cooling seat ventilation system 120 may be controlled to only activate with regards to portions of the seat 115 in contact with the occupant and/or venting/ductwork may be controlled to direct airflow only toward the occupant.

It should be noted that by de-powering or reduced powering any of the plurality of occupant environment conditioning devices that would otherwise be active, the occupant environment conditioning system 110 will use less energy and, in the case of an electric vehicle for example, increase the driving range capability, and in the case of a traditional or alternative fuel vehicle will increase the miles/unit fuel.

It should also be noted that the occupant environment conditioning system 110 may operate the ventilation system 130 without the aid of other occupant environment conditioning devices based on the principals of evaporative cooling. To this effect, the power management controller 112 may control the plurality of occupant environment conditioning devices based upon the difference between the desired occupant compartment temperature and the actual occupant compartment temperature. In this case, the power management algorithm calculated the cooling effect perceived by an occupant based upon the wind chill effect and with the power cost calculation operated the cooling sources 126 and 128 as little as possible to conserve energy. It must be understood that this includes the airflow to the climate zone 113 or to the occupant seat 115.

In another embodiment, the power cost analysis includes the use of the temperature gradient, the disparity between the desired and actual temperatures of the occupant compartment, in conjunction with the energy cost to operate a particular occupant environment conditioning device along with the energy cost to prime that device, or bring the device into a fully functional state. The power management controller 112 will then operate the plurality of occupant environment conditioning devices based upon the results of the analysis. Thus the power management controller 112 will operate the plurality of occupant environment conditioning devices based on power consumption.

It should be noted that in one embodiment the system 110 includes adaptive or switchable ducting in the ventilation system 130 to direct the plurality of other occupant environment conditioning device to any of the climate zones 113 or occupant seats 115 in a variety of occupant zones 113 as desired.

Additionally, it is expected that in addition to reduced power consumption as compared to conventional occupant environment conditioning systems, the occupant environment conditioning system 110 will have faster perceived temperature change to the occupant, based upon the efficient use of the plurality of occupant environment conditioning devices with the power management algorithm.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An occupant environment conditioning system for a vehicle comprising:
a user input device indicating a desired environmental condition of a vehicle occupant compartment;
a vehicle system input device indicating at least one parameter of the vehicle;
a plurality of occupant environment conditioning device that generate heating or cooling for altering an environment of the vehicle occupant compartment; and
a controller responsive to the desired environmental condition of occupant compartment indicated by the user input device, and the vehicle parameter indicated by the system input device to operate the occupant environment conditioning devices for generating heating or cooling based on a power consumption.

2. The occupant environment conditioning system of claim 1 wherein the vehicle system input device is an occupant sensor for indicating the presence of an occupant in a vehicle seat.

3. The occupant environment conditioning system of claim 1 wherein the plurality of occupant environment conditioning devices includes a device that is integrated into a vehicle seat.

4. The occupant environment conditioning system of claim 1 wherein the plurality of occupant environment conditioning devices includes a thermo-electric device.

5. The occupant environment conditioning system of claim 4 wherein the thermo-electric device is a Peltier device.

6. The occupant conditioning system of claim 4 wherein the thermo-electric device is a ceramic device.

7. The occupant environment conditioning system of claim 3 wherein the device integrated into the vehicle seat is a ventilated device.

8. The occupant environment conditioning system of claim 1 wherein the user input device is one of a key fob and a remote control.

9. The occupant environment conditioning system of claim 1 further comprising:
a plurality of user input devices each indicating a desired condition of a plurality of climate zones defined within the vehicle occupant compartment,
wherein the controller is responsive to input from the plurality of user input devices to operate the plurality of occupant environment conditioning devices.

10. The occupant environment conditioning system of claim 1 further comprising:
a plurality of vehicle system input devices wherein the controller is responsive to input from the plurality of vehicle system input devices to operate the plurality of occupant environment conditioning devices.

11. A method of operating an occupant environment conditioning system for a vehicle comprising the steps of:
a. providing a user input device that indicates a desired condition of a vehicle passenger compartment;
b. providing a vehicle system input device that indicates at least one parameter of the vehicle;
c. providing a device that generates heating or cooling for altering an environment of a vehicle occupant;
d. providing a controller programmed a power management algorithm including a power cost analysis;
e. evaluating the desired condition indicated by the user input device, and the vehicle parameter indicated by the system input device with the power management algorithm; and
f. operating the device with the controller based at least in part upon the evaluating in step e.

12. The method of claim 11 further comprising the steps of:
g. defining a plurality of occupant climate zones within the vehicle; and
h. determining the occupancy of at least one climate zone with the vehicle system input device;
wherein the power management algorithm is response to the occupancy determined in step h.

13. The method of claim 11 wherein the device is associated with a ventilation system including an air handler and wherein the operating in step f. includes deactivating the device and one of running the air handler in a ventilated mode and a recirculation mode.

14. An occupant environment conditioning system for a vehicle comprising:
a vehicle system input device indicating at least one parameter of the vehicle;
an occupant environment conditioning device for altering an environment of a vehicle occupant; and
a controller that operates the device based on the vehicle parameter indicated by the system input device.

15. The system of claim 14 wherein the parameter of the vehicle is one of the presence of an occupant in a vehicle seat and a position of an occupant in a vehicle seat.

16. The system of claim 15 wherein the system input device is an occupant sensor for an airbag assembly.
